(19) United States
(12) Patent Application Publication
(10) Pub. No.: US 2013/0120788 A1
(43) Pub. Date: May 16, 2013

(54) Image Processing For Images With Aroma Information

(71) Applicant: Shen Wang, Webster, NY (US)

(72) Inventor: Shen Wang, Webster, NY (US)

(21) Appl. No.: 13/295,954

(22) Filed: Nov. 14, 2011

(51) Int. Cl. G06K 15/02; G06K 9/00

(52) U.S. Cl. 358/1.15; 382/103

(57) ABSTRACT

A method and apparatus for processing a digital image by automatically detecting an object in the digital image, automatically determining that an identifiable scent corresponds to the detected object, and automatically storing information in association with the digital image for identifying the scent.

### CROSS REFERENCE TO RELATED APPLICATIONS

U.S. patent application Ser. No. 12/846,260, entitled “Apparatus and Method for Printing in both Image and Aroma Domains Intelligently”, filed Nov. 15, 2010, is assigned to the same assignee hereof, Eastman Kodak Company of Rochester, N.Y., and contains subject matter related, in certain respect, to the subject matter of the present application.

Reference is made to commonly assigned, co-pending U.S. patent application Ser. No. ______ by Wang, filed of even date herewith entitled “Image Processing for Images with Aroma Information”; and commonly assigned, co-pending U.S. patent application Ser. No. ______ by Wang, filed of even date herewith entitled “Image Processing for Images with Aroma Information”.

The above-identified patent applications are incorporated herein by reference in their entirety.

### FIELD OF THE INVENTION

The present invention relates generally to printer technology, and more particularly to printing scented images and processing and storing image files with aroma information.

### BACKGROUND OF THE INVENTION

Traditional printer technology prints images in an image domain, either color or monochrome. In addition, prior-art methods include effects applied to paper to make images on paper more interesting. For example, some images are embossed so that people can touch and feel them, which might be referred to as the tactile domain. Some images have buttons behind them so that a music or a song will play if the buttons are activated, which may be referred to as the auditory domain. Some images will have perfume smell such as a cosmetic catalog to attract consumers, which we refer to herein as the aroma domain. U.S. Pat. No. 5,975,675 describes a printer that can spray perfume onto paper in addition to printing text characters and images. As described in U.S. Pat. No. 5,975,675 the type of perfume is pre-selected or user-input. The disclosure of this patent is incorporated herein by reference in its entirety.

Another U.S. Pat. No. 5,995,770, describes a system to allow a user to pre-select an applicable scent which is to be applied to an image. Then, at the photofinishing site the scent can be delivered to a print, or a set of prints, along with an image. The disclosure of this patent is incorporated by reference herein in its entirety.

The technology described in the prior art is useful for mass printing of identical brochures or catalogs for advertising. A limitation common to these prior art patents is that the scent is pre-selected and the region of the print where the scent is applied is pre-determined as well. Furthermore, there is no disclosure of ways to store and process scent information and scents in association with digital images.

Therefore, there is a need for a printing system that will intelligently detect image content and will print either the image alone or the image together with a selected scent applied to selected locations on the image receiver.

### SUMMARY OF THE INVENTION

A preferred embodiment of the present invention comprises a method for processing a digital image by automatically detecting an object in the digital image, automatically determining that an identifiable scent corresponds to the detected object, and automatically storing information for identifying the scent in association with the digital image. Object information for identifying the detected object is also automatically stored in association with the digital image. A connected network is used for transmitting the digital image and the associated information and for receiving the digital image, which can include the object information associated with the digital image. Packet generation can be used for transmitting the digital image comprising storing the associated information identifying the scent and information identifying the detected object in a header of the packet. Multiple detected objects and scents can be similarly processed and communicated over the network.

Another preferred embodiment of the present invention comprises an apparatus having a processing system for processing a digital image, automatically detecting an object in the digital image, automatically determining that an identifiable scent corresponds to the detected object, and for automatically storing information in association with the digital image for identifying the scent. The object information for identifying the detected object can also be stored in association with the digital image. The processing system can include a network connection and means for receiving and transmitting the digital image and the associated information identifying the scent over the network. The processing system can identify a sender of the received digital image and return the digital image and the associated information identifying the scent over the network to the sender.

Another preferred embodiment of the present invention comprises an apparatus having a processing system for processing a digital image file, for reading from the digital image file information identifying an object included in a digital image of the digital image file, for automatically determining that an identifiable scent corresponding to the identified object, and for automatically storing information in the received digital image file for identifying the scent.

In the present patent application, the term “network” is intended to include a wired and a wireless network, such as either in a home, office, local area, or global, and is intended to include Wi-Fi, Wi-Max, Bluetooth and emerging technologies that may be interchangeable with currently known technologies. These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications. The figures below are not drawn to any precise scale with respect to relative size, angular relationship, or relative position or to any combinational relationship with respect to interchangeability, substitution, or representation of an actual implementation.

### BRIEF DESCRIPTION OF THE DRAWINGS

Embodiments of the invention are better understood with reference to the following drawings. The elements of the drawings are not necessarily to scale relative to each other.

FIG. 1 is a diagram of a printer in accordance with an embodiment of the invention;

FIG. 2 is a block diagram of the printing process in accordance with an embodiment of the invention;

FIG. 3 is a diagram of a camera showing an image with a person holding a flower;

FIG. 4 is a print of the image from the printer in accordance with an embodiment of the invention;

FIG. 5 is a diagram of a scent print head with nozzles in accordance with an embodiment of the invention;

FIG. 6 is a diagram of locations of the ink and scent print heads along with the print medium path inside a printer in accordance with another embodiment of the invention; and

FIG. 7 illustrates a fragrance wheel;

FIG. 8 illustrates a flow chart according to an embodiment of the present invention;

FIG. 9 illustrates an electronic file structure useful in understanding an embodiment of the present invention;

FIGS. 10A and 10B illustrate alternative electronic file structures useful in understanding an embodiment of the present invention;

FIG. 11 illustrates a flow chart according to an embodiment of the present invention;

FIG. 12 illustrates a flow chart according to another embodiment of the present invention;

FIG. 13 is a schematic illustrating a method of an embodiment of the present invention; and

FIG. 14 is a schematic illustrating an alternative method of an embodiment of the present invention.

FIG. 15 is an illustration of a processing system useful for implementing embodiments of the present invention.

FIG. 16 is an illustration of an embodiment of the processing system of FIG. 15.

### DETAILED DESCRIPTION OF THE INVENTION

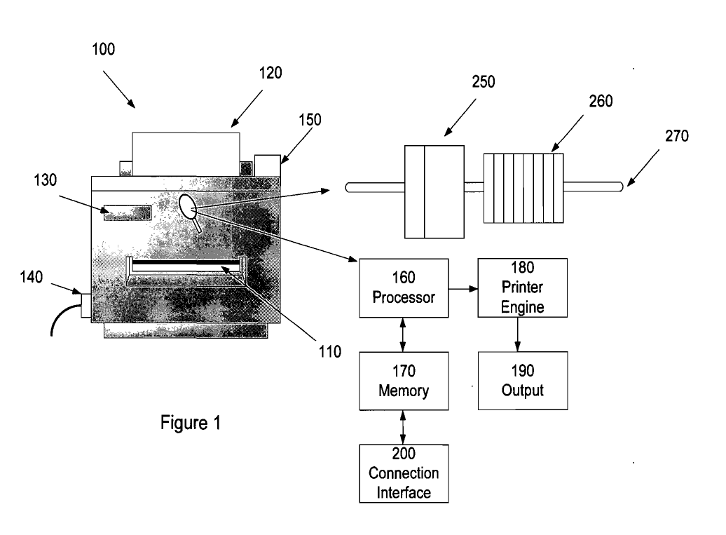

FIG. 1 is a diagram of a printer in a preferred embodiment of the present invention. Printer 100 consists of a print-medium loading cartridge 110, an output medium tray 120, an input bay 130 for a multimedia card reader, a connection port section 140 for networking and a panel control 150. The panel control 150 can be configured with function buttons like “start”, “stop”, “reset” or “resume”, etc; or it can be a touch-screen display which allows a user to control the printer 100 by touching the screen regions associated with specific functions. The printer comprises a processor 160 for image processing and for controlling the printer engine. The processor can have a single (central processing unit) CPU or multiple CPUs and can reside, for example, in one or integrated circuits. A memory 170 inside the printer 100 is used to load and buffer images and to store printer programs for processing images. The printer engine 180 includes ink cartridge 250 and scent cartridge 260 seated on a carriage bar 270 which operates in a standard fashion but for the addition of the scent cartridge and control of the movements of the scent cartridge for applying scented fluids from the scent cartridges. The scent cartridge 260 includes at least one or more scent reservoirs (not shown) which each hold at least one or more scented fluids and are coupled to the scent print head in a manner equivalent to the coupling of the ink cartridges to the ink print head. The printer 100 also includes a mechanism to transport the print medium in a standard manner, and electronics to control the printer's operation (not shown). A connection interface 200 includes circuitry for communication between various drives 130 and the network connection 140. An output 190 of the printer includes the output media tray 120.

It is understood that the actual physical design of the printer can be flexible. For example, the ink cartridge 250 and scent reservoir 260 can be situated on separate carriage bars.

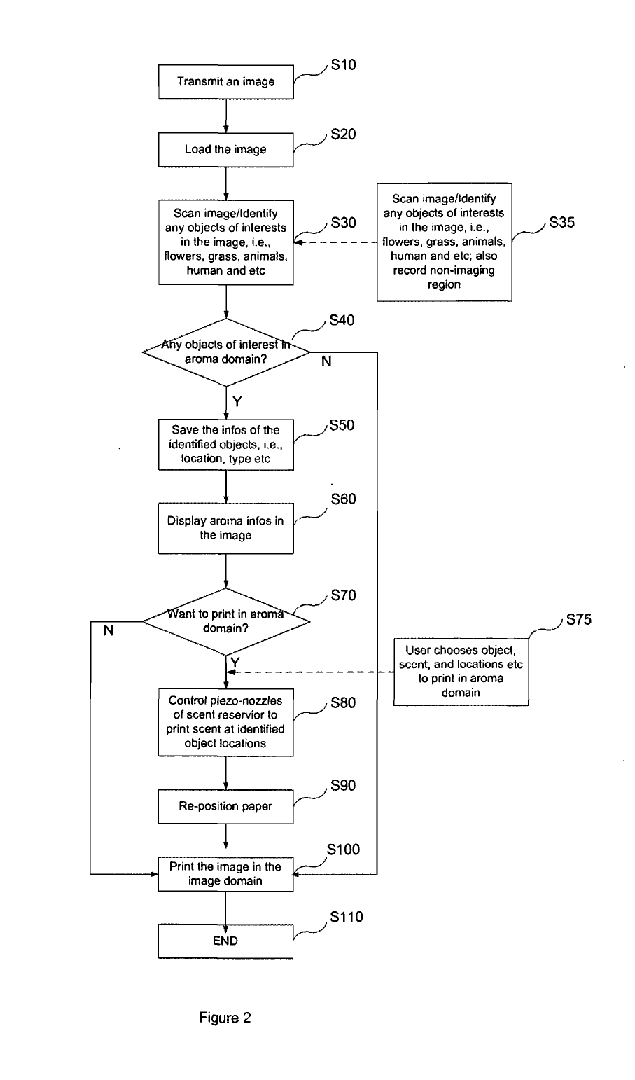

FIG. 2 illustrates a flowchart of the printer operation in accordance with a preferred embodiment of the present invention. A user sends an image to the printer 100 either by networking cable 140, wirelessly, or by inserting a disk, flash drive, or any other storage medium which provides the image in the input bay 130 (step S10). The printer 100 loads the image in its buffer memory 170 (step S20). The processor 160 in the printer 100 analyzes the image. Object recognition algorithms detect the existence of any object of interest in the image which might correspond to an object for which a scent can be applied to the print medium, such as flowers, animals, human, etc. (step S30). For example, U.S. Pat. No. 7,324,693 teaches an algorithm to detect a human figure in images automatically and reliably, the disclosure of which is incorporated by reference herein in its entirety. The algorithm first searches characteristic features such as human eyes in an image, computes the locations of the found features, determines the boundary parameters of the characteristic features like the human body, computes a set of the indicative pixel values for a contour of the boundary, and finally automatically outlines the contour of the characteristic features like the human body.

Methods of detecting other objects such as flowers are also described in the prior art. One example is “An automatic visual Flora—segmentation and classification of flower images” by Maria-Elena Nilsback, Robotics Research Group, Department of Engineering Science, University of Oxford, PhD Thesis, 2009, which describes methods to automatically recognize and classify different flowers in relatively reliable way. The object recognition algorithm is implemented in a form of a computer program loaded and saved in the printer memory 170. The object recognition algorithm identifies any objects of interest detected in the image (step S40) for which a scent is associated. If such an object is detected, the printer, under control of the program stored in the printer memory, generates information about the objects such as the type of object, location coordinates in the image relative to the image size, and the associated scent (step S50). This detection algorithm can be simply incorporated in a preferred embodiment of the present invention as a binary step of detecting whether an image of a flower exists in the digital image and, if so, applying a single scent to the image, wherein the scent fluid reservoir contains only the single scented fluid or perfume. Next the printer touch screen 150 displays the information related to the image including the objects which can be printed in the aroma domain (block S60). The printer can automatically apply a scent or request the user to select print scents for the detected objects through a pop-up window (step S70). For example, the printer analyzes an image and detects a flower. It displays the location of the flower, type of scent, etc. It asks the user for confirmation to print the scent. The user can either accept or reject the scent print. This option can prevent unwanted scented prints.

Optional preferred embodiments of the present invention are illustrated in the flowchart of FIG. 2 include a printer with no user interaction (skip step S70) or with more user interaction by letting users choose different scents, onto different objects, at different locations (step S75 can be inserted in the process flow for this optional preferred embodiment of the present invention). Another option can include the user choosing a light or a heavy scent print. The heavy scent will last longer than the light scent. One way to implement the heavy scent print or greater intensity of scent is simply to apply scent at the same location twice so that more scent fluid is deposited on the print medium. Another way is to implement different sizes of the scent nozzles for each scent reservoir in the scent print head. These types of differential-sized nozzles are used in print heads for current ink jet printers. In a scent print head utilizing differential-sized nozzles, the heavy scent print can use the large size of the nozzle and the light scent print can use the small size of the nozzle because the larger sized nozzles deliver more scented fluid than the smaller sized ones. It is also understood that more than two levels of intensity of scent can be designed as well.

The printer 100 then controls the printer engine 180 to move the print medium to the right location and starts to print scent by controlling the print head of the scent reservoir 260 in the locations where the objects are located relative to the image (step S80) and starts to print the scent in the selected locations. When the printer finishes the scent print, it rolls back the print medium to the exact start position as before (step S90). The final step is to print the image in the normal course using the standard ink cartridge 260 (step S100) and the process is finished (block S110). The user can bypass the scent printing (step S70) so the printer returns directly to the block S100 to print the image in the image domain. If there are no objects detected corresponding to scented fluids in the printer, the printer prints the image directly as a normal printer does by jumping from step S40 to step S100 directly, and completes the printing process (step S110).

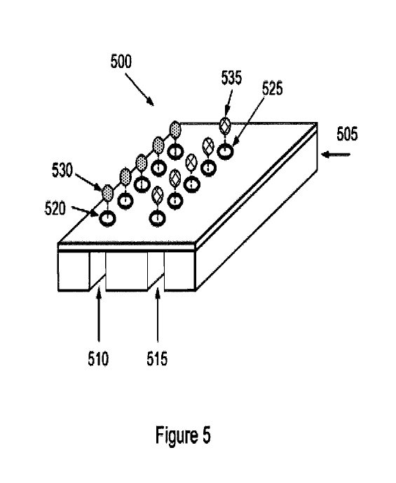

FIG. 5 shows a scent print head 500 which can eject scent in accordance with a preferred embodiment of the invention. The print head 500 is built on a die substrate 505. Separate pathways 510 and 515 from separate scat sources transfer the scent liquids to the arrays of print nozzles 520 and 525. Two scent liquid reservoirs (not shown) are connected to the pathways to supply the scent liquids. Although two scent sources are shown in FIG. 5, it is understood that a single scent source or more than two scent sources can be configured in the print head 500. A droplet of a first scent fluid 530 is ejected from the nozzle 520 and a droplet of a second scent fluid 535 is ejected from the nozzle 525. The ejection is controlled, as in the normal course of a non-scented printer by electronics in the print head 500 controlled by the printer processor 160.

The print head can include a piezoelectric transducer to compress the volume of a scented fluid causing scent fluid ejection. Or the print head can include a heating element to vaporize a portion of the scent fluid and therefore cause ejection, both of which are commonly used in inkjet printers.

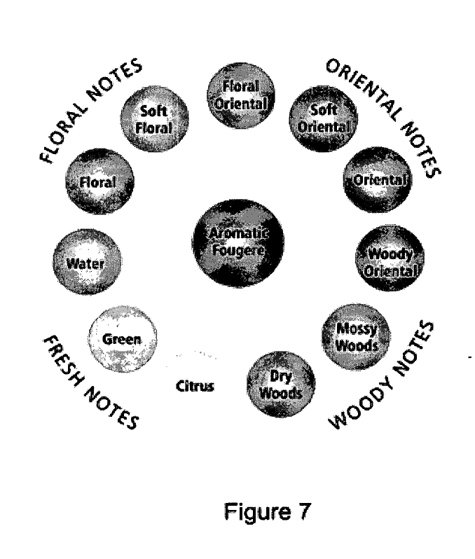

Much work has been done to classify scents, especially “good” or appealing scents such as a fragrance. For example, M. Edwards in 1983 developed a so-called “Fragrance Wheel” shown in FIG. 7 to classify different fragrances. Five different fragrance types can be characterized as Floral, Oriental, Woody, Fougère, and Fresh, with the former four families being more “classic” while the last one consists of newer bright and clean smelling citrus and oceanic fragrances that have been developed due to improvements in fragrance technology. The fragrances can be manufactured using natural ingredients such as flower or plant extracts, or by synthetic chemical compounds. Preferably, the printer 100 will print appealing or attractive scents like fragrance or perfume onto an image. However, it is understood that any kind of scent including non-appealing ones can be applied to the image if desired.

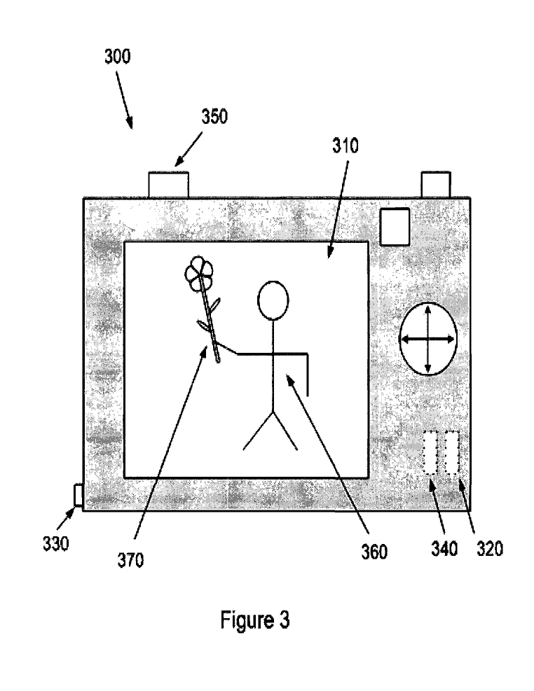

FIG. 3 shows an example of an image 310 displayed in a digital camera 300. The camera has an SD card 320, USB port 330 and a wireless card 340 to connect to a network which includes printer 100 in accordance with a preferred embodiment of the present invention. Inside the camera 300, an image 310 is saved in an SD card 320. The image 310 shows a person 360 holding a flower 370. The image can be transferred to the printer either by the SD card 320 or a USB connection 330. Alternatively, the user can transmit the image to the designated printer 100 wirelessly through wireless interface 340. An input such as a touch screen, button, or voice activation can be implemented to allow a user to control this step. The user then sends the image 310 to the printer 100 either by wireless transmission, or by the SD card.

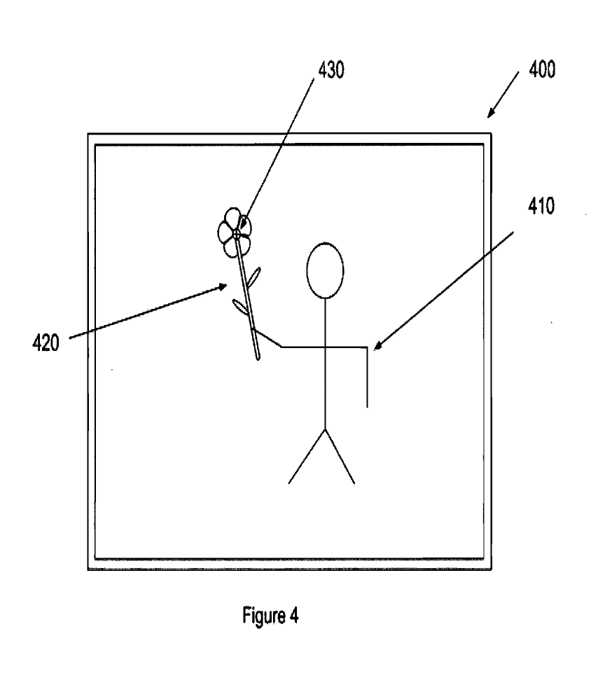

FIG. 4 shows the print 400 of the image 310 from the camera as output from the printer. In the print 400, there is a person 410 holding a flower 420. In addition to the visual effect of the picture, the printer also prints a flower scent in the center of the flower 430 so that it has an appealing effect. Although one scent, i.e., of a flower, is shown in FIG. 4, it is understood a printer comprising multiple scent reservoirs can store scent fluids from different flowers if the object detection algorithm is able to recognize different kinds of flowers. It is also understood that a printer can not only print a scent of flowers, but also other scents from other objects such as trees, oceans, etc., based on the printer's configuration. Alternative preferred embodiments of the present invention also include applying a scent right at an object's location on a print; printing in a non-imaging region, such as in a margin or border of the print media, and printing on a back of the print medium. For example, if a printer is dedicated to print only scents of nature such as flowers, the detection algorithm should be able to detect these objects reasonably reliably and the printer should include the scent-fluid reservoirs for these objects. In addition, a printer can be configured to print any combination of scents if necessary as long as the technique of detection algorithm and the scent fluid is available.

It is also understood that the scent location in FIG. 4 is not limited to one location. In a preferred embodiment of the present invention, the scent is printed right at the center of the related object. In this case, the center of the flower 430 is the preferred scent print location if the scent fluid does not react with the ink. This is true for a printer that uses pigment-based ink. For example, U.S. Pat. No. 7,795,327 discloses water dispersions containing pigment-containing water-insoluble vinyl polymer particles and water-based inks containing the water dispersions. If the scent fluid reacts with the ink, the printer needs to print the scent in either a non-imaging region in the print, such as in a blank space or in a margin of the print medium, or on the back of the print medium.

In the case of printing scent in a non-imaging region, the detection algorithm can record the region without any imaging content after performing the detecting step (step S35 to replace step S30 in FIG. 2 for this optional embodiment). The region without any imaging content is easy to detect. For a normal image, the pixel intensity of a non-imaging region is zero or substantially zero. Therefore, a block of pixels with zero or substantially zero intensity indicates a non-imaging region.

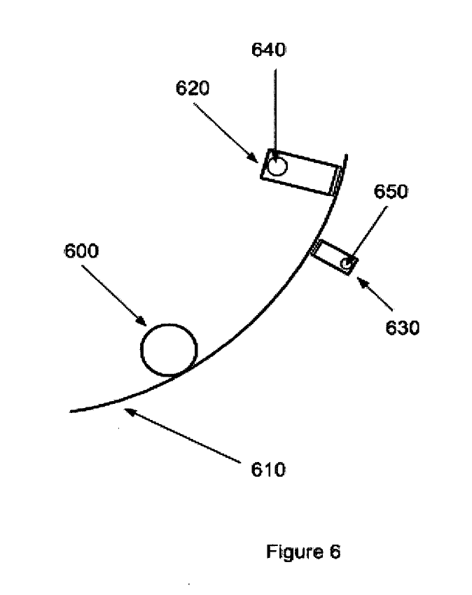

In the case of print scent on the back of a print, the printer 100 can be modified. Instead of having the ink print head and scent print head on the same carriage rail, the scent print head is located on the opposite side of the print medium. FIG. 6 shows a portion of the section inside the printer 100 which includes a print medium roller 600 to transfer the print medium 610 through the printer. An ink print head 620 is located on one side of the medium while the scent print head 630 is located on the other side of the medium. The ink reservoir through-hole 640 enables the ink print head 620 to be mounted in front of the print medium and to allow the ink print head 620 to move across the print medium from the front side. In the meantime, the scent reservoir through-hole 650 enables the scent print head 630 to be mounted on the back of the print medium and to allow the scent print head to move across the print medium from the back side. Alternatively, a scent applicator or scent print head can be mounted in a stationary position for backside printing, and so can be equipped with a simple spray atomizer for applying scented fluids or perfumes to a back side of a print medium. This configuration will allow the printer to print image on one side and the scent on the other side of the print medium. The rest of the printer design can be identical to the printer 100 described above.

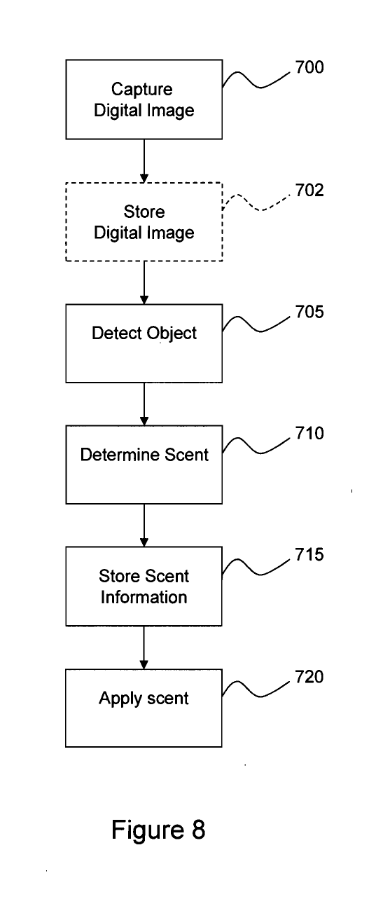

Referring to FIG. 8, in another preferred embodiment of the present invention, a method includes using a digital capture device to capture one or more digital images in step 700. A program as described above for automatically detecting an object in one of the captured digital images is performed in step 705. Storage containing a table of objects and corresponding scents is provided in a processing system for automatically determining a scent corresponding to the detected object in step 710, and the storage can be used for automatically storing determined scent information with the detected object and stored in association with the captured digital image in step 715. Once the scent information is determined and stored in association with the digital image, as described in more detail below, the image file can be transmitted to a compatible printer configured to interpret the transmitted scent information where the previously described scented fluid can be applied by the printer (FIG. 1) in step 720. The scent corresponding to the determined scent information is applied spatially to the printed object in the printed captured digital image, for example by inkjet printing as described above. By applying spatially is meant that the area on a medium on which the digital image is printed corresponding to the detected object is printed with the scent determined to match the object. The object in the print is printed with ink to illustrate the object in the digital image and is also printed with the determined scent.

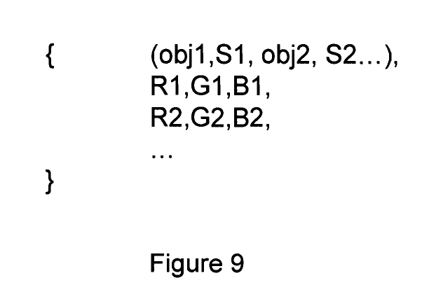

Referring to FIG. 9, the scent information and detected object can be stored in an electronic memory in an image file. The scent information and object can be considered metadata associated with the digital image and stored, as shown, in a header as part of the file. The header (enclosed in parentheses) includes an object specification (e.g. object type and location obj1 and scent identification S1). Multiple objects and scent identifiers can be stored in the header corresponding to multiple objects and associated scents found in the digital image and matched to the objects in the database. The header information can be stored as structured information, for example in a standardized structure such as extended markup language or XML. Such storage structures are known in the prior art. Objects can be stored, for example, with a descriptive name and a location, bounding box, key salient feature list, poses, sizes, generic description, pixel list, or a perimeter or boundary descriptor.

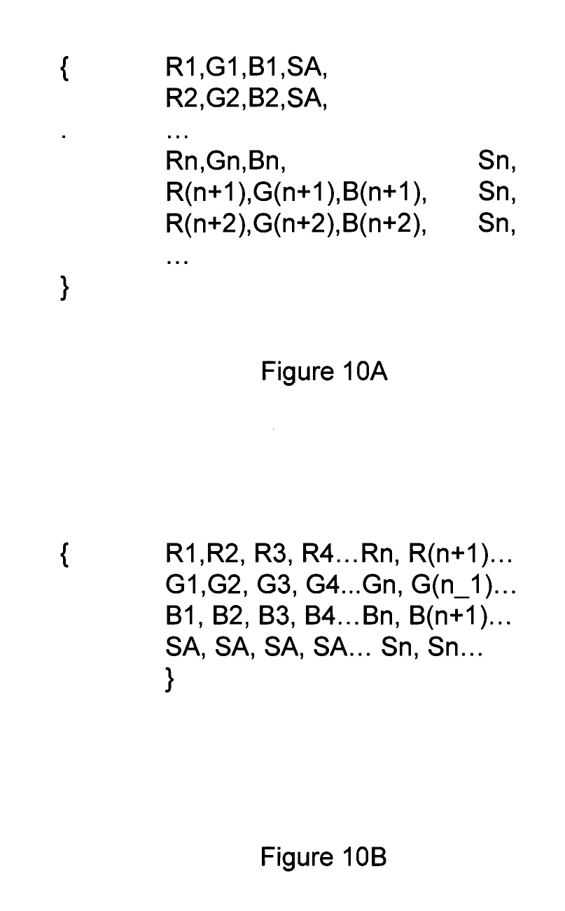

Referring to the examples of FIGS. 10A and 10B, the scent information and object are associated directly with digital image pixels and stored in an electronic memory as a file. Each pixel has an associated scent value (that can also include “no scent”). Groups of pixels form objects, but in such a storage structure the objects themselves do not need to be separately identified, so long as the corresponding scent is stored with each pixel. The scent information can be associated with each color pixel as an additional channel (FIG. 10A) or considered an additional plane (FIG. 10B), for example a scent channel or plane corresponding to the color pixel elements in a color image. As shown in both FIGS. 10A and 10B for the example of a three-color digital-image specification, each pixel includes one red, one green, one blue, and one scent value. Multiple pixels can have a common scent value. Different scent values can be associated with different color pixels so that different or separate objects can have different scents or the same scent.

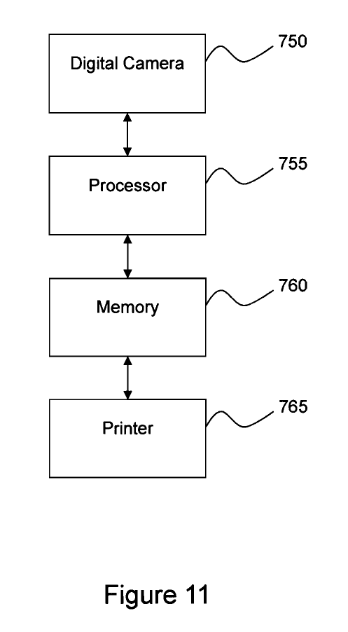

Referring to FIG. 11, digital capture devices include digital cameras, cell-phones with digital camera components 750, and smart phones with digital camera components 750. These devices are operated by orienting the capture device toward a scene of interest and triggering a digital-image-capture operation, for example a button or other shutter controls such as touch-screen, and voice command, either electronic or mechanical. The digital camera will then electronically capture an image of the scene as an array of digital values representing the scene. Typically, an array of values is formed for each of three colors representing each pixel of a full-color image.

Means for automatically detecting an object in one of the captured digital images can be provided using image-processing circuits having access to electronic storage circuits or devices, for example such as processor 755 with electronic storage memory 760 found in programmable digital computer circuits or in non-programmable digital circuits, e.g. such as gate arrays or other integrated circuits. Suitable programs for controlling programmable devices are known in the art and are described above. Such programs analyze the digital image to detect objects.

Likewise, image-processing circuits, for example as found in programmable or non-programmable digital computer circuits, such as processors 755 with electronic storage circuits 760 are useful for determining scents associated with an object found in a digital image. Computer programs, for example stored in the electronic memory 760 can access a database or library of image objects also stored in the electronic memory 760 or in a remote memory accessible through a network (not shown), wherein each image object is associated with one or more identified scents. Using the processor 755 and program, the detected object can be compared to each object in the database or library to determine a match and the scent identified with the matched object can be included with the matched object as object information. The object information can be stored in the electronic storage, e.g. a data retrieval system, for example volatile or non-volatile memory, rotating magnetic or optical memory, or solid-state memory. The object information can be stored in association with the captured digital image.

In various preferred embodiments of the present invention, the object detection and scent determination are performed using components of a processing system. In a preferred embodiment of the present invention, the printer includes a processor (e.g. 755) and memory (e.g. 760) that stores programs and a database including objects and associated scents. The digital image is transferred, e.g. through a network, from the digital camera to the printer. Other means of transfer include a smart disk (SD) and a universal serial bus (USB). The digital image is analyzed in the printer processor, one or more objects detected, a corresponding object found in the database, and a corresponding scent determined. The digital image can be printed with objects in the image overlaid with the determined scents. The determined scent information is stored with the detected object and the captured digital image in the electronic memory and can be available or transmitted to other devices connected to a network common to the printer.

In other preferred embodiments of the present invention, a computer separate from the printer, such as a desktop, notebook, net-book or laptop computer, includes a processor (e.g. 755) and memory (e.g. 760) that stores programs and a database including objects and associated scents. The digital image can be transferred, e.g. through a network or digital peripheral interface (e.g. a universal serial bus), from the digital camera to a separate computer if the programmed processing described herein is not provided on the processing device itself. The digital image is analyzed remotely in the network computer processor, one or more objects detected, a corresponding object found in the database, and a corresponding scent determined. The determined scent information is stored with the detected object and the captured digital image in the electronic memory and can be available or transmitted to other devices connected to a network common to the printer. The stored digital image with object and scent information is then transferred, for example through a network, to a printer for printing on a medium.

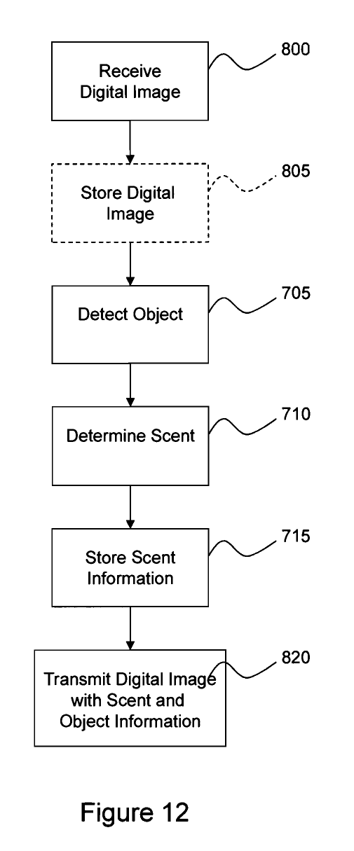

In another preferred embodiment of the present invention, the separate computer is a remote server computer accessed through a network. The remote server computer can be provided by an imaging services provider and can be a single processor or multi-processor server. The digital image is transferred to the remote server computer automatically, or through user selection, which user selection is input on a user device, through a network (e.g. the internet). The remote server computer includes a processor (e.g. 755 FIG. 11) and memory (e.g. 760 FIG. 11) that stores programs and a database including objects and associated scents. Referring to FIG. 12, the digital image is transferred from the digital camera to the remote server computer and received by the remote server computer (step 800). The digital image is analyzed in the remote computer processor, one or more objects detected (step 705), a corresponding object found in the database, and a corresponding scent determined (step 710). The determined scent information is stored with the detected object (step 715) and the captured digital image in the electronic memory and can be available or transmitted to other devices connected to a network common to the remote server computer. The stored digital image with object information, or scent information, or both, is then transmitted (step 820), for example through a network, to a compatible printer for interpreting the scent information stored with the digital image and printing on a medium. The stored digital image with object or scent information, or both, can also be transmitted (forwarded) to another user, after determining scent information and object information, who may store the image and associated information for printing on a local printer. Clearly, it is preferable for this local printer to be compatible with the object information or scent information or both, in order to print the digital image and apply the identified scent to the print. The originating user supplies the electronic address of the recipient (another user) via the communication transmission to the remote server. The server accesses the electronic address in the communication for forwarding to the other user.

In another preferred embodiment of the present invention, a processor (e.g. 755) and memory (e.g. 760) that stores programs and a database including objects and associated scents can be provided within a digital camera or other digital imaging device that includes a digital camera, such as a cell-phone or smart-phone. The digital image is analyzed in the digital imaging device, one or more objects detected, a corresponding object found in the database, and a corresponding scent determined. The determined scent information is stored with the detected object and the captured digital image in the electronic memory and can be available or transmitted to other devices connected to a network common to the digital imaging device. The stored digital image with object and scent information is then transferred, for example through a network, to a compatible printer for interpreting the scent information stored with the digital image and printing on a medium.

In another preferred embodiment of the present invention a captured digital image is stored in an electronic storage device before it is analyzed for objects associated with scent identifiers, for example before (step 702 FIG. 8) or after (step 805 FIG. 12) transferring the one captured digital image to the computer server through the communication network.

Thus, according to various preferred embodiments of the present invention, an object in a captured digital images can be automatically detected and a scent corresponding to the detected object automatically determined with a processor in a digital camera, a processor in a printer, a processor in a computer separate from a digital camera or printer, a processor in a portable computer, a processor in a cellular telephone, or a processor in a computer server accessible through a network. The detected object and associated information can be stored as metadata in a header associated with a digital image electronic file or with each digital image pixel as an additional image plane or channel in a digital image electronic file. The digital image can be stored in an electronic storage device without additional information or with the metadata or image channels or image planes.

In a preferred embodiment of the present invention, a plurality of objects can be automatically detected in a digital image. The plurality of objects can have different associated scents that can be printed with the different scents in the different image object areas. Thus, a first scent corresponding to a first detected object can be determined, a second scent corresponding to a second detected object can be determined, and the first scent and the second scent can be different scents.

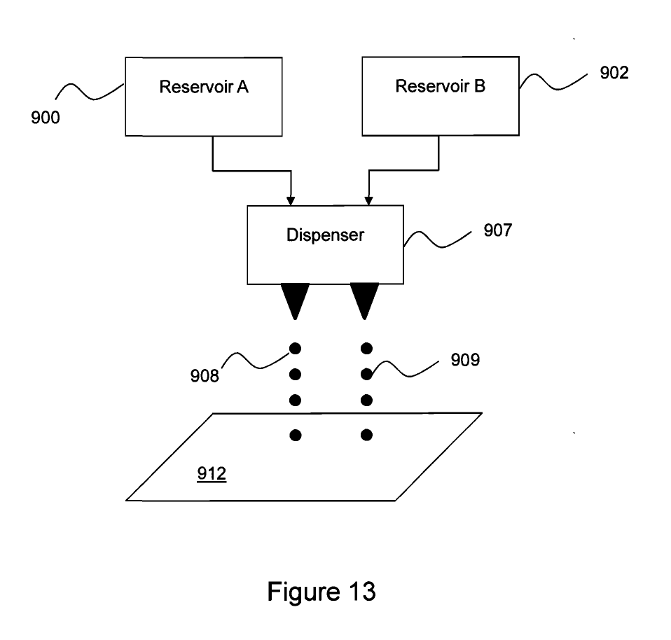

Referring to FIG. 13, each printed scent can be provided as a separate scent fluid stored in a separate scent cartridge. The scent fluid can be, for example, inkjet printed or atomized and deposited on the location of the associated object in the printed digital image with a dispenser onto a printing medium. Alternatively, an applied scent can be determined to be a combination of two or more different scents that are each applied to the same object area. Therefore, a first scent can include second and third scents that are both applied to a common object area. Second and third scents can be applied to the same pixel or, in a multi-pixel object, different pixels within the same object can have different scents. Since human olfactory acuity is inadequate to distinguish two different scents on two neighboring pixels, the object will effectively have the first scent combining both second and third scents. Referring to FIG. 13, in one preferred embodiment of the present invention, each of the second and third scents are separately provided in scent cartridges (reservoir A 900 and reservoir B 902) applied to a common object area on a printed-image medium 912 from a multi jet dispenser 907 expelling separate drops of scent 908, 909.

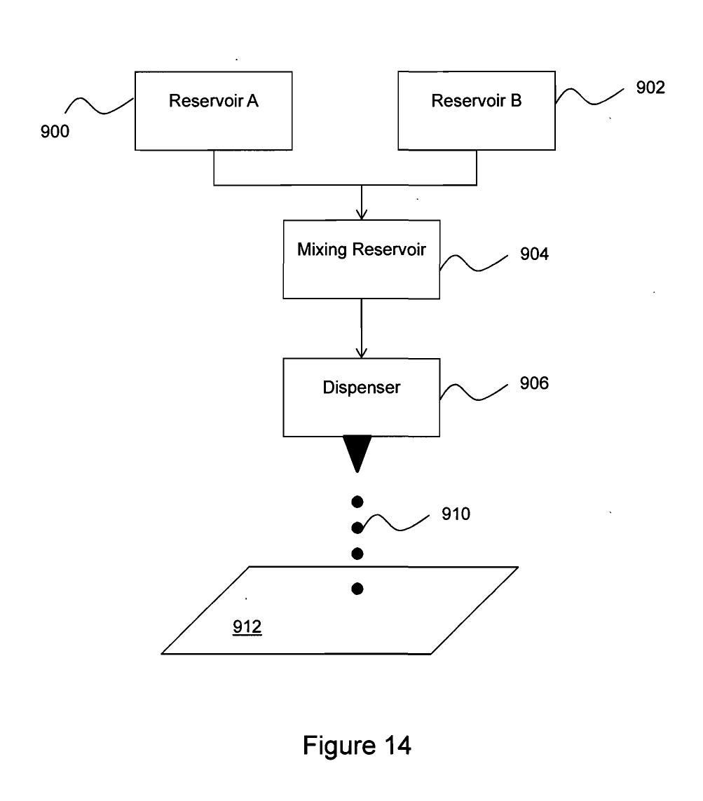

Referring to FIG. 14, in another preferred embodiment of the present invention, each of the second and third scents is transferred from separate scent cartridges (e.g. reservoir A 900 and reservoir B 902) mixed together, for example in a mixing reservoir 904 and the mixed scents are applied together to a common object area on a printed-image medium 912 from a dispenser 906.

In another preferred embodiment of the present invention, a first scent can be determined to be a chemical interaction of second and third scents rather than the simple combined presence of each of the second and third scents. The second and third scents can both be applied to a common object area on a printed-image medium where they chemically interact to provide the desired first scent. Alternatively, the second and third scents can be mixed in a reservoir where they chemically interact to provide the desired first scent and are applied together to a common object area on a printed-image medium.

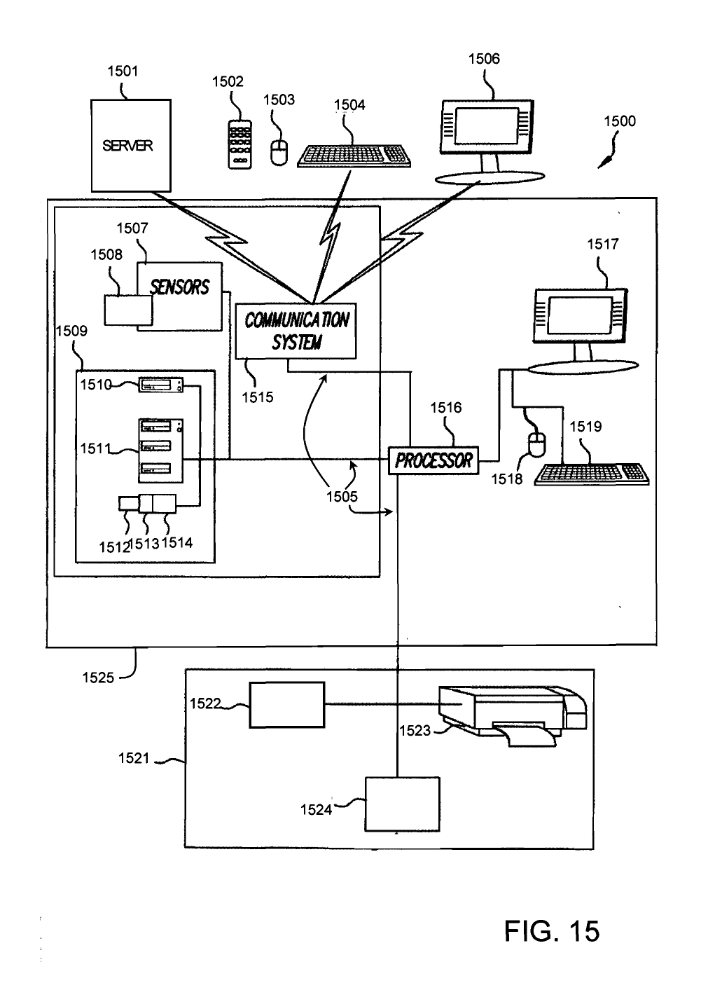

FIG. 15 illustrates in a generic schematic format a computing system for implementing preferred embodiments of the present invention. Electronic apparatus and processing system 1500 is used for automating digital image object detection and corresponding scent identification. In a preferred embodiment as illustrated in FIG. 15, processing system 1500 comprises a housing 1525 and local memory or storage containing data files 1509, optional remote user input devices 1502-1504, local user input devices 1518-1519, an optional remote output system 1506, and a local output system 1517, wherein all electronics are either hardwired to processor system 1516 or optionally connected wirelessly thereto via Wi-Fi or cellular through communication system 1515. Output systems 1506 and 1517 depict display screens and audio speakers. While these displays and speakers are illustrated as standalone apparatuses, each can also be integrated into a hand held computing system such as a smart phone. The computer system 1500 may include specialized graphics subsystem to drive output display 1506, 1517. The output display may include a CRT display, LCD, LED, or other forms. The connection between communication system 1515 and the remote I/O devices is also intended to represent local network and internet (network) connections to processing system 1516. Optional remote server 1501 can represent a network accessible processing system, storage, and processing/storage such as used to implement cloud computing technology. Remote and local storage (or memory) illustrated in FIG. 15 can be used as necessary for storing computer programs and data sufficient for processing system 1516 to execute the algorithms disclosed herein. Data systems 1509, user input systems 1502-1504 and 1518-1519 or output systems 1506 and 1517, and processor system 1516 can be located within housing 1525 or, in other preferred embodiments, can be individually located in whole or in part outside of housing 1525.

Data systems 1509 can include any form of electronic or other circuit or system that can supply digital data to processor system 1516 from which the processor can obtain digital images for identifying objects and corresponding scents. In this regard, the data files delivered from systems 1509 can comprise, for example and without limitation, programs, still images, image sequences, video, graphics, multimedia, and other digital image and audio programs such as slideshows. In the preferred embodiment of FIG. 15, sources of data files also include those provided by sensor devices 1507, data received from communication system 1515, and various detachable or internal memory and storage devices coupled to processing system 1516 via systems 1509.

Sensors 1507 are optional and can include light sensors, audio sensors, image capture devices, biometric sensors and other sensors known in the art that can be used to detect and record conditions in the environment of system 1500 and to convert this information into a digital form for use by processor system 1516. Sensors 1507 can also include one or more sensors 1508 that are adapted to capture digital still or video images. Sensors 1507 can also include biometric or other sensors for measuring human voluntary and involuntary physical reactions, such sensors including, but not limited to, voice inflection detection, body movement, eye movement, pupil dilation, and body temperature sensors.

Storage/Memory systems 1509 can include conventional memory devices such as solid state, magnetic, HDD, optical or other data storage devices, and circuitry for reading removable or fixed storage media. Storage/Memory systems 1509 can be fixed within system 1500 or can be removable, such as HDDs and floppy disk drives. In the embodiment of FIG. 15, system 1500 is illustrated as having a hard disk drive (HDD) 1510, disk drives 1511 for removable disks such as an optical, magnetic or specialized disk drives, and a slot 1514 for portable removable memory devices 1512 such as a removable memory card, USB thumb drive, or other portable memory devices, including those which may be included internal to a camera or other handheld device, which may or may not have a removable memory interface 1513 for communicating through memory slot 1514. Although not illustrated as such, memory interface 1513 also represents a wire for connecting memory devices 1512 to slot 1514. Data including, but not limited to, control programs, digital images, application programs, metadata, still images, image sequences, video, graphics, multimedia, and computer generated images can also be stored in a remote server 1501, as well as locally, such as in a personal computer, network server, computer network or other digital system such as a cloud computing system. Remote server 1501 is shown coupled to processor system 1516 wirelessly, however, such systems can also be coupled over a wired network connection or a mixture of both.

In the embodiment shown in FIG. 15, system 1500 includes a communication system 1515 that in this embodiment can be used to communicate with a remote server 1501, an optional a remote display 1506, and/or optional remote inputs 1502-1504. A remote input station including remote display 1506 and/or remote input controls 1502-1504 communicates with communication system 1515 wirelessly, as illustrated, or can communicate as a wired network. Local input station including either or both a local display system 1517 and local inputs can be connected to processor system 1516 using a wired (illustrated) or wireless connection such as Wi-Fi or infra red transmission.

Communication system 1515 can comprise for example, one or more optical, radio frequency or other transducer circuits or other systems that convert image and other data into a form that can be conveyed to a remote device such as remote server 1501 or remote display device 1506 configured with digital receiving apparatus, using an optical signal, radio frequency signal or other form of signal. Communication system 1515 can also be used to receive a digital image and other digital data from a host or server computer or network (not shown) or a remote server 1501. Communication system 1515 provides processor system 1516 with information and instructions from corresponding signals received thereby. Typically, communication system 1515 will be adapted to communicate with the remote server 1501, or output system 1506 by way of a communication network such as a conventional telecommunication or data transfer network such as the internet, a cellular, peer-to-peer or other form of mobile telecommunication network, a local communication network such as wired or wireless local area network or any other conventional wired or wireless data transfer system.

User input systems provide a way for a user of system 1500 to provide instructions, or selections via a customized user interface, to processor system 1516. This allows such a user to make a designation of digital image files to be used in identifying objects captured in the images and any corresponding scents such as stored in a look-up table. User input system 1502-1504 and 1518-1519 can also be used for a variety of other purposes including, but not limited to, allowing a user to select image files for transmission over a network to another user, or to a server that comprises features for identifying objects in a digital image, or for identifying scents corresponding to identified objects, or both, to enter metadata not otherwise extractable by the computing system, and to perform such other interactions with system 1500 as will be described herein.

In this regard user input systems 1502-1504 and 1518-1519 can comprise any form of transducer or other device capable of receiving an input from a user and converting this input into a form interpreted by processor system 1516. For example, user input system can comprise a touch screen input at 1506 and 1517, a touch pad input, a 4-way switch, a 6-way switch, an 8-way switch, a stylus system, a trackball system or mouse such as at 1503 and 1518, a joystick system, a voice recognition system such as at 1508, a gesture recognition system such as at 1507, a keyboard, a remote control 1502, cursor direction keys, on screen keyboards, or other such systems. In the embodiment shown in FIG. 15, remote input system can take a variety of forms, including, but not limited to, a remote keyboard 1504, a remote mouse 1503, and a remote control 1502. Local input system includes local keyboard 1519, a local mouse 1518, microphone 1508, and other sensors 1507, as described above.

Additional input or output systems 1521 are used for rendering images, text or other graphical representations in a manner that allows a digital image to be reproduced with an applied scent on an image medium. In this regard, input/output systems 1521 can comprise any conventional structure or system that is known for providing, printing or recording images, including, but not limited to, scent compatible printer 1523 and, for example, scanner 1522. Printer 1523 can record images on a tangible surface using a variety of known technologies including, but not limited to, conventional four color offset separation printing. Other contact printing such as silk screening can be performed or dry electrophotography such as is used in the NexPress 2100 printer sold by Eastman Kodak Company, Rochester, N.Y., USA, thermal printing technology, drop on demand ink jet technology, and continuous inkjet technology, or any combination of the above which is represented at 1522-1524. For the purpose of the preceding discussions, printer 1523 will be described as being of a type depicted in FIG. 1 that generates color images printed upon compatible media and applies selected scented fluids as described herein. However, it will be appreciated that this is not required and that the methods and apparatuses described and claimed herein can be practiced with a printer 1523 that prints monotone images such as black and white, grayscale or sepia toned images.

In certain embodiments, the source of data files 1509, user input systems 1502-1504 and output systems 1506, 1517, and 1521 can share components. Processor system 1516 is capable of controlling system 1500 based upon signals from user input system 1502-1504 and 1518-1519, sensors 1507-1508, storage/memory 1509 and communication system 1515. Processor system 1516 can include, but is not limited to, a programmable digital computer, a programmable microprocessor, a programmable logic processor, multi-processing systems, a chipset, a series of electronic circuits, a series of electronic circuits reduced to the form of an integrated circuit, or a series of discrete components on a printed circuit board.

As will be described below, processing system 1500 can be configured as a workstation, laptop, kiosk, PC, and hand held devices such as cameras and smart phones. As an exemplary workstation, the computer system central processing unit 1516 communicates over an interconnect bus 1505. The CPU 1516 may contain a single microprocessor, or may contain a plurality of microprocessors for configuring the computer system 1500 as a multi-processor system, and high speed cache memory comprising several levels. The memory system 1509 may include a main memory, a read only memory, mass storage devices such as tape drives, or any combination thereof. The main memory typically includes system dynamic random access memory (DRAM). In operation, the main memory stores at least portions of instructions for executions by the CPU 1516. For a workstation, for example, at least one mass storage system 1510 in the form of an HDD or tape drive, stores the operating system and application software. Mass storage 1510 within computer system 1500 may also include one or more drives 1511 for various portable media, such as a floppy disk, a compact disc read only memory (CD-ROM or DVD-ROM), or an integrated circuit non-volatile memory adapter 1514 (i.e. PC-MCIA adapter) to provide and receive instructions and data to and from computer system 1500.

Computer system 1500 also includes one or more input/output interfaces 142 for communications, shown by way of example as an interface for data communications to printer 1523 or another peripheral device 1522-1524. The interface may be a USB port, a modem, an Ethernet card or any other appropriate data communications device. The physical communication links may be optical, wired, or wireless. If used for scanning, the communications enable the computer system 1500 to receive scans from a scanner 1522, or documentation therefrom, to a printer 1523 or another appropriate output or storage device.

As used herein, terms such as computer or “machine readable medium” refer to any tangible, non-transitory medium that stores or participates, or both, in providing instructions to a processor for execution. Such a medium may take many forms, including but not limited to, non-volatile media and volatile media. Non-volatile media include, for example, optical or magnetic disks, flash drives, and such as any of the storage devices in any computer(s) operating as one of the server platforms, discussed above. Volatile media include dynamic memory, such as main memory of such a computer platform. Transitory physical transmission media include coaxial cables; copper wire and fiber optics, including the wires that comprise a bus within a computer system, a carrier wave transporting data or instructions, and cables or links transporting such a carrier wave. Carrier-wave transmission media can take the form of electric or electromagnetic signals, or acoustic or light waves such as those generated during radio frequency (RF) and infrared (IR) data communications. Common forms of non-transitory computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

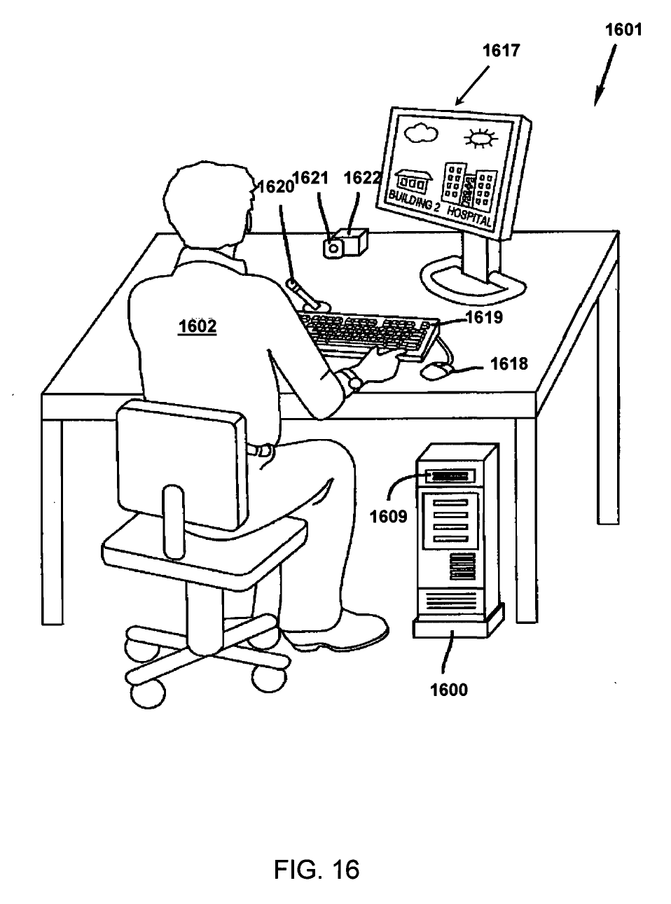

As is illustrated in FIG. 16, an example implementation of the processing system just described is embodied as example workstation 1600 and connected components as follows. Processing system 1600 and local user input system 1618-1622 can take the form of an editing studio or kiosk 1601 (hereafter also referred to as an “editing area”), although this illustration is not intended to limit the possibilities as described in FIG. 15 of potential implementations. Local storage or memory 1609 can take various forms as described above with regard to data systems 1509. In this illustration, a user 1602 is seated before a console comprising local keyboard 1619 and mouse 1618 and a local display 1617 which is capable, for example, of displaying multimedia content. As is also illustrated in FIG. 16, the editing area can also have sensors 1620-1622 including, but not limited to, audio sensors 1620, camera or video sensors 1622, with built in lenses 1621, and other sensors such as, for example, multispectral sensors that can monitor user 1602 during a user production session. Display 1617 can be used as a presentation system for presenting output products or representations of output products in final form or as works-in-progress. It can present output content to an audience, such as user 1602, and a portion of sensors 1621, 1622 can be adapted to monitor audience reaction to the presented content. It will be appreciated that the material presented to an audience can also be presented to remote viewers.

The invention has been described in detail with particular reference to certain preferred embodiments thereof, but it will be understood that variations and modifications can be effected within the spirit and scope of the invention. For example, the embodiments described herein the sequence of process flow to print can be changed in terms of the order of printing in image domain or in aroma domain.

### PARTS LIST

100 printer
110 print medium loading cartridge
120 output medium tray
130 an input bay
140 connection port
150 panel control
160 processor
170 memory
180 printer engine
190 output
200 connection interface
250 ink cartridge
260 scent cartridge
270 cartridge bar
S10 step
S20 step
S30 step
S35 step
S40 step
S50 step
S60 step
S70 step
S75 step
S80 step
S90 step
S100 step
S110 step
300 digital camera
310 image inside the camera
320 SD card
330 USB port
340 wireless card
350 button
360 a person in the image
370 a flower in the image
400 a print with the image
410 a person in the print
420 a flower in the print
430 the center of the flower
500 scent print head
505 die substrate
510 pathway
515 pathway
520 print nozzle
525 print nozzle
530 scent liquid
535 scent liquid
600 print medium roller
610 print medium
620 ink print head
630 scent print head
640 through-hole for ink print head
650 through-hole for scent print head
700 capture digital image step
702 store digital image step
705 detect object step
710 determine scent step
715 store scent information step
720 apply scent step
750 digital camera components
755 processor
760 memory storage
765 printer
800 receive digital image step
805 store digital image step
820 transmit digital image and object and scent information step
900 scent reservoir A
902 scent reservoir B
904 scent mixing reservoir
906 multi jet scent dispenser
907 scent dispenser
908 scent A drops
909 scent B drops
910 mixed scent drops
912 medium
1500 Processing System
1501 Remote System
1502 Remote Control
1503 Mouse
1504 Keyboard
1505 Bus
1506 Remote Output
1507 Sensors
1508 Image Sensor
1509 Storage/Memory
1510 HDD
1511 Drive
1512 Removable Device
1513 Interface
1514 Slot
1515 Communication System
1516 Processor/CPU System
1517 Local Output
1518 Mouse
1519 Keyboard
1521 I/O Devices
1522 Scanner
1523 Printer
1524 I/O Device
1525 Housing
1600 Workstation/PC
1601 Control/Editing Area
1602 User
1609 Storage/Memory
1617 Local Output
1618 Mouse
1619 Keyboard
1620 Audio Sensor
1621 Image Sensor
1622 Sensor System

1. Method comprising:
a processing system receiving a digital image;
the processing system automatically detecting an object in the received digital image;
the processing system automatically determining that an identifiable scent corresponds to the detected object; and
the processing system automatically storing information for identifying the scent, the information for identifying the scent stored in association with the digital image.

2. The method of claim 1, wherein the step of automatically storing further includes automatically storing object information for identifying the detected object in association with the digital image.

3. The method of claim 1, wherein the processing system is connected to a network and the method further comprises transmitting the digital image and the associated information identifying the scent over the network.

4. The method of claim 3, wherein the step of transmitting further comprises storing the associated information identifying the scent and information identifying the detected object in the digital image corresponding to the scent in a header of an electronic file that includes the digital image.

5. The method of claim 1, wherein the processing system is connected to a network, and wherein the step of receiving includes receiving the digital image over the network, and further comprising transmitting the digital image and the associated information identifying the scent over the network to a network connected printer, the printer adapted to interpret the information identifying the scent and for applying the identified scent on a print of the digital image, the print of the digital image printed by the network connected printer.

6. The method of claim 1, wherein the processing system is connected to a network and wherein the step of receiving includes receiving the digital image over the network, and further comprising identifying a sender of the received digital image, and transmitting the digital image and the associated information identifying the scent over the network to the sender.

7. The method of claim 1, wherein the processing system is connected to a network, the step of receiving includes receiving a data transmission over the network that include the digital image, and wherein the method further comprises identifying a sender of the received digital image, identifying an intended recipient of the received digital image, and transmitting the digital image and the associated information identifying the scent over the network to the intended recipient.

8. The method of claim 5, wherein the step of identifying an intended recipient comprises reading the data transmission for an electronic address of the intended recipient, the electronic address provided in the data transmission by the sender.

9. The method of claim 1, wherein the step of automatically determining includes accessing a database that includes data identifying the object in the captured digital image and data associating the scent with the object.

10. The method of claim 9, wherein the database is a network connected database and the step of automatically determining includes accessing the database over the network.

11. The method of claim 1, further comprising:
the processing system automatically detecting a second object in the received digital image;
the processing system automatically determining that an identifiable second scent corresponds to the second detected object; and
the processing system automatically storing information for identifying the second scent, the information for identifying the second scent stored in association with the digital image.

12. Method comprising:
a processing system receiving a digital image file;
the processing system reading from the digital image file information identifying an object included in a digital image of the digital image file;
the processing system automatically determining that an identifiable scent corresponds to the identified object; and
the processing system automatically storing information for identifying the scent in the received digital image file.

13. The method of claim 12, wherein the step of the step of automatically determining includes accessing a database comprising a plurality of objects and a plurality of identifiable scents, each of the plurality of objects associated with one or more of the identifiable scents.

14. Apparatus comprising:
a processing system for processing a digital image, including automatically detecting an object in the digital image, automatically determining that an identifiable scent corresponds to the detected object, and automatically storing information for identifying the scent, the information for identifying the scent stored in association with the digital image.

15. The apparatus of claim 14, wherein the processing system is further used for automatically storing object information for identifying the detected object in association with the digital image.

16. The apparatus of claim 14, wherein the processing system includes a network connection and the apparatus further comprises a means for transmitting the digital image and the associated information identifying the scent over the network.

17. The apparatus of claim 16, wherein the processing system is used for storing the information identifying the scent and the information identifying the detected object in the digital image corresponding to the scent in a header of an electronic file that includes the digital image.

18. The apparatus of claim 16, wherein the processing system receives the digital image over the network and transmits the digital image and the associated information identifying the scent over the network to a network connected printer.

19. The apparatus of claim 16, wherein the processing system identifies a sender of the received digital image and transmits the digital image and the associated information identifying the scent over the network to the sender.

20. Apparatus comprising:
a processing system for processing a digital image file, for reading from the digital image file information identifying an object included in a digital image of the digital image file, for automatically determining that an identifiable scent corresponding to the identified object, and for automatically storing information in the received digital image file for identifying the scent.
